(19) United States
(12) Patent Application Publication
(10) Pub. No.: US 2016/0374334 A1
(43) Pub. Date: Dec. 29, 2016

(54) METHOD FOR REDUCING SPRAY DRIFT

(71) Applicant: LAMBERTI SpA, Albizzate (Varese) (IT)

(72) Inventors: Rocco DI MODUGNO, Spring, TX (US); Mauro Riccaboni, Legnano (Milano) (IT); Valentina Langella, Milano (IT); James Dean Reiss, West Dundee, IL (US); Giovanni Floridi, Novara (IT); Giuseppe Li Bassi, Gavirate (Varese) Italia (IT)

(73) Assignee: LAMBERTI SpA, Albizzate (Varese) (IT)

(21) Appl. No.: 14/754,164

(22) Filed: Jun. 29, 2015

(51) Int. Cl. A01N 25/30; A01N 39/04; C09K 3/30; A01N 57/20

(52) U.S. Cl. CPC A01N 25/30; A01N 57/20; A01N 39/04; C09K 3/30

(57) ABSTRACT

Spray drift may be reduced during spray applications. Spray drift during the application of a pesticidal or crop protection spray tank solution may be reduced by mixing the pesticidal or crop protection spray tank solution with a drift control formulation containing a maltodextrin and a C₁₂-C₂₂ mono- or di-carboxylic acid or a salt thereof.

### BACKGROUND OF THE INVENTION

### Field of the Invention

The present invention relates to a method for reducing spray drift. The present invention particularly relates to reducing spray drift during spray applications to crops.

The problem of “drift”, or “spray drift”, is well known in connection with the aerial spraying of water during the fire fighting operations and the spraying of aqueous compositions of agrochemicals, such as systemic herbicides, plant growth regulators, pesticides, insecticides, and the like.

Spray drift is spray material that misses the target during application or moves off the target after application.

Spray drift is a restriction factor which reduces the efficiency of pesticidal treatments, therefore it costs money through inefficient and off target application. It also increases the impact of chemicals on the environment and can adversely affect non-target plants.

Moreover spray drift can pollute adjacent water courses, groundwater, landscapes, and woodland. Drift can bring the applicator and members of the public into increased contact with potentially harmful or unpleasant chemicals.

Spray drift is caused by a combination of factors such as wind speed, local atmospheric conditions, nozzle choice, sprayer pressure, vehicle speed, boom height and chemical factors.

Previous research has focused on reducing spray drift by altering the sprayer features, such as nozzles and pressure of the sprayer and by using spray adjuvants such as drift control agents to optimize droplet size distribution reducing the smallest droplets and limiting the increasing of coarser ones.

The drift control agents (or anti-drift agents) change the visco-elastic properties of the spray liquid, more specifically by reducing its stretching capability (elongational viscosity) and its tendency to separate into smaller droplets. These factors result in narrower spray with a limited percentage of larger droplets and a reduced percentage of smaller droplets, i.e. those having a diameter below 150 microns.

A number of drift control additives are commercially available.

Typical drift control additives that are known since many years are synthetic or natural polymers, such as polyacrylamides, polyethylene oxides, polyvinyl pyrrolidones, guar gum and guar gum derivatives; maltodextrins have also been cited among gums and colloids that explicate a certain spray drift control (U.S. Pat. No. 6,364,926).

Presently, in particular in the agriculture industry, polyacrylamides, guar gum and its derivatives are still the standard tank additives for spray drift reduction.

Nonetheless, drawbacks of polymeric drift control agents are known to exist. According to the patent literature these are mainly:
Narrow concentration range of efficacy (WO 2013/050006)
Tendency to degrade under high shear and long dissolution time (WO 2012/076567)
Poor performance in high speed aerial application (WO 2011/156320 and WO 2010/051435)
Cost (WO 2010/051435)
Reduced bioefficacy due to broad drop size distribution and excessive increase in average particle size (WO 2012/145177 and WO 2012/076567).

Despite the fact that surfactants reduce the surface tension of spray solutions and are thus expected to reduce the average particle size and increase the number of small droplets, recently, the above cited patent literature broadly describes the use of large classes of non polymeric surfactants as drift control agents.

It would be desirable in the art to employ a drift control agent that can be utilized in an aqueous spray medium and which provides for excellent drift control performance. It would be particularly desirable in the art if such a control agent has a good balance between fine droplets reduction and increase in average droplet size.

### SUMMARY OF THE INVENTION

In one aspect, the invention is a method for reducing spray drift during spray application of a pesticidal or crop protection spray tank solution which comprises tank mixing the solution with a drift control formulation containing a maltodextrin and a C₁₂-C₂₂ mono- or di-carboxylic acid, or a salt thereof.

In another aspect, the invention is a drift control formulation containing from 20 to 75% by weight of a maltodextrin, from 1 to 5% by weight of a C₁₂-C₂₂ mono- or di-carboxylic acid, or a salt thereof, and from 20 to 79% by weight of water.

We have now discovered that a drift control agent, based on maltodextrins and a C12-C22 mono- or di-carboxylic acid, or salt thereof, can be utilized in an aqueous spray medium providing excellent drift control performances, showing a good balance between fine droplets reduction and increase in the droplets average particle size.

Unexpectedly, the addition of C12-C22 mono- or di-carboxylic acids or salts thereof to maltodextrins has proven to improve their drift control effect.

In addition, the liquid drift control agent based on maltodextrins and fatty acids or salts thereof may be considered highly eco-friendly, represents an economically attractive substitute to common drift control agents, can be easily incorporated in the tank mix to be sprayed and does not adversely affect its rheology.

### DETAILED DESCRIPTION OF THE INVENTION

In one embodiment, the method for reducing spray drift during spray applications includes tank mixing a pesticidal or crop protection spray tank solution with a drift control formulation containing a maltodextrin and a C ₁₂-C₂₂ mono- or di-carboxylic acid or salt thereof. The drift control formulation may be applied to any pesticidal or crop protection spray tank solution containing, as active ingredients, for example, pesticides or crop protection agents, such as herbicides, fungicides, insecticides, plant growth regulators, fertilizer, and mixture thereof. For the purposes of this application, the term “pesticidal” has its normal English meaning, namely “substance or agent used to kill pests, such as unwanted or harmful insects, rodents, or weeds.” (Online Dictionary: the freedictionary.com). For the purposes of the present application, the term pesticide also includes substances or agents to kill fungi. This method is particularly useful for reducing spray drift during spray application of pesticidal spray tank solutions containing herbicides, fungicides, insecticides, and plant growth regulators.

When the solution to be sprayed is a crop protection solution, in some embodiments it is desirably a fertilizing solution containing as the active substance, by way of example: ammonia salts, such as ammonium sulfate, ammonium bisulfate, ammonium salts of carboxylic acids, ammonium chloride, ammonium carbonate, ammonium phosphate; urea and urea derivatives; phosphate sources, such as phosphoric acid and salts thereof; potash sources, like potassium phosphate (mono- or di-), potassium carbonate, potassium citrate, potassium nitrate; compounds containing micronutrients and secondary nutrients like zinc, manganese, magnesium, iron, calcium, sulfur, boron, etc; and mixture thereof.

When the formulation is a pesticidal solution, in some embodiments it is desirably a herbicidal solution, containing as the active substance, in particular: glyphosate, 2,4-D, glufosinate, dicamba, atrazine, paraquat, triclopyr, aminopyralid, or mixture thereof. More desirably, the herbicidal solution contains glyphosate and 2,4-D, or glyphosate and dicamba; most desirably it contains glyphosate and 2,4-D.

The pesticidal or crop protection spray tank solutions of the method are aqueous diluted solutions that can be sprayed on the fields. For the purposes of this application, the term “diluted” mean that the pesticidal or crop protection spray tank solutions have an active substance(s) concentration of from about 0.001 to about 50 g/l.

Water typically represents at least 90% by weight of the aqueous diluted solutions.

The pesticidal or crop protection spray tank solutions are usually prepared in loco by the farmer or contractor by mixing concentrated pesticidal formulations of active substances (that can be in various forms, for instance neat liquids or powders, granules, aqueous solutions, concentrated suspensions, concentrated emulsions, suspoemulsions (aka suspension emulsions), or the like), water and possibly other additives, such as thickeners, wetting agents, deposition enhancers, solvents, surfactants, anti-foam agents, anti-freeze agents, colorants, dispersants, stabilisers, preservatives, buffers evaporation retardants, frost protecting agents, UV protecting agents, fragrances, anti-foam agents and the like.

The drift control formulation containing a maltodextrin and a C₁₂-C₂₂ mono- or di-carboxylic acid or salt thereof, is one that typically contains from 20 to 75% by weight of a maltodextrin and from 1 to 5% by weight of a C₁₂-C₂₂ mono- or di-carboxylic acid or salt thereof, and can be incorporated at any step during preparation of the pesticidal or crop protection spray tank solutions.

Typically, the method for reducing spray drift during spray application of a pesticidal or crop protection spray tank solution comprises tank mixing the solution with 0.05 to 2 percent vol/vol of the drift control formulation that contains from 20 to 75% by weight of a maltodextrin and from 1 to 5% by weight of a C₁₂-C₂₂ mono- or di-carboxylic acid or a salt thereof.

The drift control formulation is liquid and pourable and desirably contains from 20 to 79% by weight of water.

The characterizing ingredients of the drift control formulations are maltodextrins and C₁₂-C₂₂ mono- or di-carboxylic acids or salts thereof. Maltodextrins are starch hydrolyzates. The wide range of maltodextrins commercially available are described in terms of their “Dextrose Equivalent” value (DE), which is a measure of the amount of their reducing sugars, relative to dextrose, expressed as a percentage on a dry basis. The DE of maltodextrins varies between 3 and 20 and gives an indication of their average degree of polymerization (DP).

Desirably, the maltodextrin in the drift control formulation has a DE from 6 to 18, more desirably from 10 to 16, and is thus highly water-soluble.

The C₁₂-C₂₂ mono- or di-carboxylic acids in the drift control formulation may be chosen from among C₁₂-C₂₂ fatty acids and C₈-C₁₈ alkyl or alkenyl succinic acids. Desirably they are C₁₂-C₂₂ fatty acids, that may be saturated or unsaturated, of vegetable or animal origin, more desirably the C₁₂-C₂₂ mono- or di-carboxylic acids in the drift control formulation is an olein which is an unsaturated C₁₈ fatty acid. For the purposes of clarity, the subscripted 12 and 22 in the above general formulae refer to the total number of carbons in the molecule. For example, a C8-C18 alkyl or alkenyl succinic acid would be within the scope of a C-12-C22 fatty acid because the succinic acid would contribute 4 carbons to the 8 carbons in the substituent for a total of 12 carbons.

For the purposes of this application, the term olein has its normal meaning in English, namely an ester of glycerol and oleic acid (see, online dictionary: Merriam-webster.com).

According to one embodiment of the method, the maltodextrin in the drift control formulation is underivatized, i.e. it is one commercially available that has been obtained from starch by hydrolysis, without further reaction with derivatizing agents.

In this embodiment, for the preparation of the drift control formulation, the underivatized dextrin, the C₁₂-C₂₂ mono- or di-carboxylic and optionally a base, such as KOH or NaOH, typically KOH, or the C₁₂-C₂₂ mono- or di-carboxylic acid salt, may be dissolved in water, in any order, under moderate mechanical stirring and heating.

Desirably, for the preparation of the drift control formulation in which the maltodextrin is underivatized, the proper amount of a base such as KOH or NaOH, typically KOH, is firstly dissolved in water, subsequently the C₁₂-C₂₂ mono- or di-carboxylic acid (or the corresponding acyl halide or anhydride) is added to the alkalinized solution and, lastly, the underivatized dextrin, is therein dissolved, typically under moderate mechanical stirring and heating.

The temperature during preparation of the formulation should not exceed 120° C., to avoid degradation of the maltodextrin.

When the anti drift control formulation contains a mono- or di-carboxylic acid salt, the proper amount of the base is the stoichiometric quantity needed to at least partially salify the acid.

Desirably the C₁₂-C₂₂ mono- or di-carboxylic acid in the formulation is totally salified.

According to one embodiment, in the method for reducing spray drift during spray application of a pesticidal or crop protection spray tank solution, the maltodextrin is underivatized and the C₁₂-C₂₂ mono- or di-carboxylic acid is a C₁₂-C₂₂ fatty acid or salt thereof, more desirably olein or a salt thereof.

According to another embodiment, in the method for reducing spray drift during spray application of a pesticidal or crop protection spray tank solution, the maltodextrin is underivatized and the C₁₂-C₂₂ mono- or di-carboxylic acid is a C₈-C₁₈ alkyl or alkenyl succinic acid or a salt thereof.

Accordingly, a desirable drift control formulation contains from 20 to 75% by weight of an underivatized maltodextrin, from 1 to 5% by weight of a C₁₂-C₂₂ mono- or di-carboxylic acid, or salt thereof, and from 20 to 79% by weight of water; more desirably in the drift control formulation the C₁₂-C₂₂ mono- or di-carboxylic acid is a C₁₂-C₂₂ fatty acid, or salt thereof, most desirably olein or a salt thereof.

In another embodiment, the drift control formulation contains from 20 to 75% by weight of an underivatized maltodextrin, from 1 to 5% by weight of a C₁₂-C₂₂ mono- or di-carboxylic acid, or salt thereof, and from 20 to 79% by weight of water, the C₁₂-C₂₂ mono- or di-carboxylic acid being a C₈-C₁₈ alkyl or alkenyl succinic acid or a salt thereof.

According to another embodiment of the method for reducing spray drift during spray application of a pesticidal or crop protection spray tank solution, the maltodextrin is hydrophobically modified, i.e. it is one commercially available that has been obtained from starch by hydrolysis and is further reacted with a hydrophobizing agent, according to procedures well known in the art.

Useful hydrophobizing agents are those that bring hydrophobic ester groups on the maltodextrin and include saturated or unsaturated C₁₂-C₂₂ acyl halides, C₁₂-C₂₂ saturated or unsaturated acids methyl, ethyl or vinyl esters, C₈-C₁₈ alkyl or alkenyl succinic anhydrides.

Desirably, in the drift control formulation, the hydrophobically modified maltodextrin is a maltodextrin fatty ester of a C₁₂-C₂₂ mono- or di-carboxylic acid having hydrophobic degree of substitution (DS_{H}) from 10⁻⁴ to 0.1 and the C₁₂-C₂₂ mono- or di-carboxylic acid is a C₁₂-C₂₂ fatty acid or a salt thereof.

More desirably, the hydrophobically modified maltodextrin is maltodextrin oleate having hydrophobic degree of substitution (DS_{H}) of from 10⁻⁴ to 0.1, most desirably from 10⁻³ to 10⁻², and the C₁₂-C₂₂ fatty acid is olein or a salt thereof.

In the method for reducing spray drift during spray application of a pesticidal or crop protection spray tank solution, the hydrophobically modified maltodextrin may also be a maltodextrin monoester of a C₈-C₁₈ alkyl or alkenyl succinic acid, having hydrophobic degree of substitution from 10⁻⁴ to 0.1, and the C₁₂-C₂₂ mono- or di-carboxylic acid a C₈-C₁₈ alkyl or alkenyl succinic acid or a salt thereof.

Drift control formulations containing from 20 to 75% by weight of a hydrophobically modified maltodextrin which is a maltodextrin fatty ester of a C₁₂-C₂₂ fatty acid having hydrophobic degree of substitution from 10⁻⁴ to 0.1, from 1 to 5% by weight of a C₁₂-C₂₂ mono- or di-carboxylic acid which is a C₁₂-C₂₂ fatty acid, or salt thereof, and from 20 to 79% by weight of water are therefore desirable; more desirably, in the drift control formulation the maltodextrin fatty ester is maltodextrin oleate and the C₁₂-C₂₂ fatty acid is olein or a salt thereof.

Drift control formulations containing from 20 to 75% by weight of a hydrophobically modified maltodextrin which is a maltodextrin monoester of a C₈-C₁₈ alkyl or alkenyl succinic acid having hydrophobic degree of substitution from 10⁻⁴ to 0.1, from 1 to 5% by weight of a C₁₂-C₂₂ mono- or di-carboxylic acid which is C₈-C₁₈ alkyl or alkenyl succinic acid, or a salt thereof, and from 20 to 79% by weight of water are also useful for the realization of the method of the invention.

According to the embodiments in which the maltodextrin in the drift control formulation is hydrophobically modified, for the preparation of the formulation, the underivatized dextrin may be dissolved in water, typically under moderate mechanical stirring and heating, the obtained solution alkalinized with a base, such as KOH or NaOH, typically with KOH, and an acyl halide of C₁₂-C₂₂ mono- or di-carboxylic acid, or a C₈-C₁₈ alkyl or alkenyl succinic anhydride, is added to the solution under continuous moderate mechanical stirring and heating.

The amount of base and the amount of acyl halide or anhydride that are added to the solution shall permit the hydrophobization reaction to take place and provide a DS_{H} from 10⁻⁴ to 0.1, as it is well known in the art.

As the yield of the hydrophobization reaction is normally below 100%, part of the acyl halide or part of the anhydride, after the hydrophobization reaction, are hydrolyzed during reaction to provide, in the final reaction mixture, the corresponding C₁₂-C₂₂ mono- or di-carboxylic acid salts. The final reaction mixture may be directly used as the drift control formulation useful for the realization of the method of the invention.

Alternatively, more C₁₂-C₂₂ mono- or di-carboxylic acid or salt thereof may added to the final reaction mixture, and water may be added or distilled off to adjust the amount of ingredient of the formulation, to provide the drift control premix containing from 20 to 75% by weight of a maltodextrin and from 1 to 5% by weight of a C₁₂-C₂₂ mono- or di-carboxylic acid or a salt thereof and from 20 to 79% by weight of water.

The drift control formulations described above containing a maltodextrin, a C₁₂-C₂₂ mono- or di-carboxylic acid, or salt thereof, and water may additionally contain up to 10% by weight of a glycol, glycol monoether, or glycerin.

Examples of glycol or glycol monoether that can be used are mono-ethylene glycol, di-ethylene glycol, mono-propylene glycol, di-propylene glycol, 2-butoxy ethanol, di-ethylene glycol mono butyl ether, tri-ethylene glycol mono butyl ether.

The here disclosed diluted agrochemical spray tank solutions do not require special spraying devices and can be applied on the target area using conventional spray equipments for aerial or ground applications.

### EXAMPLES

### Example 1

640 g of maltodextrin (DE 10-16) in powdered form was added to a solution of 320 mg of tetra-n-butylammonium bromide (TBAB) in 560 g of water, in 2-L glass reactor equipped with overhead stirrer, condenser, additional funnel and nitrogen inlet. Nitrogen is purged through the system and the contents were mixed for 5 minutes at room temperature stirring at 300-400 rpm. Potassium hydroxide (7.64 g, 85% purity) were slowly added and the reaction mixture stirred for an additional 10 minutes. The reaction temperature was raised to 50-55° C. and 24 ml of oleoyl chloride (85% purity) was added via a dropping funnel. The reaction was held at the same temperature with stirring at 200-250 rpm for 2 hours. The water was evaporated till the dry content of the product was between 55 and 75% w/w. Then, the reaction mixture was cooled to room temperature and the pH was adjusted to about 7 with phosphoric acid and stirred for about 10 minutes. The resulting mixture was collected.

### Example 2

400 g of maltodextrin (DE 10-16) in powdered form was added to a solution of 560 mg of tetra-n-butylammonium bromide (TBAB) and potassium hydroxide (4.80 g, 85% purity) in 340 g of water, in 2-L glass reactor equipped with overhead stirrer, condenser, additional funnel and nitrogen inlet. Nitrogen is purged through the system and the reaction temperature was raised to 50° C. and stirred at about 200 rpm for 30 minutes. 60 g of dodecenyl succinic anhydride (3-(dodec-1-enyl)oxolane-2,5-dione) was added dropwise and the reaction was held at the same temperature with stirring at 200-250 rpm for 2 hours. Water was evaporated till the dry content of the product was between 55 and 75% w/w. Then, the reaction mixture was cooled to room temperature and the pH was adjusted to about 7 with phosphoric acid. After being stirred for about 10 minutes, the reaction was collected.

### Example 3

24 ml of oleoyl chloride (85% purity) was added dropwise under vigoruos stirring to a solution of potassium hydroxide (7.64 g, 85% purity) in 560 g of water heated at 60° C. The reaction was stirred for 1 hour and the pH was corrected to about 7 with phosphoric acid and stirred for about 10 minutes. 640 g of maltodextrin (DE 10-16) in powdered form was portionwise added to the reaction mixture under vigorous stirring, and kept at 60° C. for 30 minutes. The water was evaporated till the dry content of the product was between 55 and 75% w/w. The mixture was cooled at about room temperature and collected.

### Example 4

48 ml of bidistilled olein was added dropwise under vigoruos stirring to a solution of potassium hydroxide (15.3 g, 85% purity) in 1120 g of water heated at 60° C. The reaction was stirred for 1 hour and the pH was corrected to about 7 with phosphoric acid and stirred for about 10 minutes. 1280 g of maltodextrin (DE 10-16) in powdered form was portionwise added to the reaction mixture under vigorous stirring, and kept at 60° C. for 30 minutes. Water was evaporated till the dry content of the product was between 55 and 75% w/w. The mixture was cooled at about room temperature and collected.

### Comparative Example 5

24 ml of oleoyl chloride (85% purity) was added dropwise under vigoruos stirring to a solution of potassium hydroxide (7.6 g, 85% purity) in 560 g of water heated at 60° C. The reaction was stirred for 1 hour and the pH was corrected to about 7 with phosphoric acid and stirred for about 10 minutes. The mixture was cooled at about room temperature and collected.

### Comparative Example 6

560 g of maltodextrin (DE 10-16) in powdered form was portionwise added to 560 g of water under vigorous stirring, and kept at 60° C. for 60 minutes. Water was evaporated till the dry content of the product was between 55 and 75% w/w. The mixture was cooled at about room temperature and collected. Table 1 summarizes the characteristics of the products described in Examples 1-6.

TABLE 1

| | | | | Carboxylic | Dry |
|---|---|---|---|---|---|
| | Maltodextrin | | Carboxylic | Acid Salt | content |
| | wt % | DS_{HB} | Acid Salt | wt % | wt % |
| Example 1 | 68.6 | 0.012 | Potassium | 1.4 | 70.1 |
| | | | oleate | | |
| Example 2 | 61.5 | 0.048 | Potassium | 4.2 | 65.8 |
| | | | dodecenyl | | |
| | | | succinate | | |
| Example 3 | 60.6 | 0.002 | Potassium | 3.2 | 63.9 |
| | | | oleate | | |
| Example 4 | 61.9 | — | Potassium | 3.0 | 65.1 |
| | | | oleate | | |
| Example 5 | — | — | Potassium | 2.4 | nd |
| | | | oleate | | |
| Example 6 | 61.3 | — | None | — | 61.3 |

### Spray Drift Tests

The antidrift properties of the drift control formulations of the invention were evaluated by determining the droplet sizes of the spray tank solutions of diluted herbicide formulations tank mixed with the concentrates of the Examples described above.

### Test 1

The test was conducted in a chamber 45″×40″48″ (H×W×L) with an optic system placed on it. The optic system is aluminum square tube (2.5″×2.5″×15″) with a board camera (Fire-I BBW 1.3, Unibrain Inc., San Ramon, Calif., USA), a high power flat LED lamp (luminous intensity 850-950 lumen, view angle 120 degree, wattage 10 w, B-TOTEM Inc, Shenzhen, China) with flashing circuit. The camera worked at a frame rate 30 fps with exposure time up to 292.14 ms. The droplet detection “window” was shaped by the size of the field of view (FOV) which was approximately 6.4 mm (horizontal)×5 6 mm (vertical) and the depth of field (DOF) which was approximately ±1.3 mm. Three different spray nozzles were used: XR11004 (40 psi) and AIXR11004 (70 psi). The total sprayed volume per trial was 10 liters.

Sprayable herbicide formulations were prepared using Roundup PowerMax® (which is a glyphosate based herbicide, commercially available from Monsanto) at a concentration of 2% v/v in water alone or adding 0.25% v/v of aqueous concentrates reported in Table 2

Water and formulation containing only the herbicide were used as reference.

The percent less than 150 μm (Pct<150 μm) is the percentage of the spray volume that is 150 μm and smaller, with percent less 210 μm (Pct<210 μm), and 600 μm (Pct<600 μm) being similar measurements.

TABLE 2

| | Pct | | |
|---|---|---|---|
| | <150 μm | <210 μm | <600 μm |
| Water | 16 | 32 | 86 |
| Roundup Power Max | 29 | 48 | 96 |
| Roundup Power Max + Example 1 | 14 | 37 | 91 |
| Roundup Power Max + Example 2 | 22 | 43 | 94 |
| Roundup Power Max + Example 3 | 17 | 42 | 94 |

Nozzle: XR110004 @ 40 psi

TABLE 3

| | Pct | | |
|---|---|---|---|
| | <150 μm | <210 μm | <600 μm |
| Water | 11 | 20 | 72 |
| Roundup Power Max | 9 | 19 | 74 |
| Roundup Power Max + Example 1 | 8 | 18 | 72 |
| Roundup Power Max + Example 2 | 9 | 19 | 76 |
| Roundup Power Max + Example 3 | 7 | 16 | 71 |
| Roundup Power Max + Interlock * | 11 | 22 | 78 |

* InterLock ® is a crop-based adjuvant from Winfield that improves spray deposition on intended targets and reduces spray drift.
Nozzle: AIXR110004 @ 70 psi

The addition of the drift control formulation concentrates of the invention results in a limited coarser spray with a reduced percentage of small droplets i.e. those having a diameter below 150 microns, which are more prone to drift. In particular, the product of Example 3 shows the lowest Pct below 150 and 230 microns using both the nozzles.

### Test 2

A Sympatec Helos/Vario KR particle size analyzer was used. This system uses laser diffraction to determine particle size distribution in a range from 18 to 3500 microns. All testing was performed in a low speed wind tunnel at 15 mph. Table 4 summarize the testing parameters.

TABLE 4

| Parameter | Value | |
|---|---|---|
| Wind speed | 15 | mph |
| Temperature | 71.6° | F. |
| Relative humidity | 36% | |
| Measurement distance | 12 | in |

| | |
|---|---|
| Particle size analyzer | HELOS KR with R7 lens |

The width of the nozzle plume was analyzed by moving the nozzle across the laser by means of a linear actuator. The tests were replicated at least three times for each diluted sprayable herbicide formulation.

Spray tank solutions were prepared by tank mixing Enlist Duo ® (glyphosate +2,4-D herbicide from Dow AgroSciences) (2% v/v) in water alone or in combination with drift control formulations (0.25% v/v) reported in Table 1.

A spray tank solution containing Enlist Duo only (2% v/v) was used as a reference.

The results are reported in Table 5 (nozzle AIXR11004 @50psi) and Table 6 (nozzle XR11004 @40 psi)

The percent less than 150 μm (Pct<150 μm) is the percentage of the spray volume that is 150 μm and smaller, with percent less 210 μm (Pct<210 μm), and 730 μm (Pct<730 μm) being similar measurements.

TABLE 5

Pct

| | <150 μm | <210 μm | <730 μm |
|---|---|---|---|
| Enlist Duo | 3.50 | 9.45 | 95.88 |
| Enlist Duo + Example 3 | 3.06 | 8.51 | 95.52 |
| Enlist Duo + Example 4 | 3.04 | 8.49 | 95.46 |
| Enlist Duo + Example 5* | 3.21 | 8.90 | 96.25 |
| Enlist Duo + Example 6* | 3.16 | 8.63 | 96.22 |

*comparative

TABLE 6

Pct

| | <150 μm | <210 μm | <730 μm |
|---|---|---|---|
| Enlist Duo | 14.18 | 32.49 | 100 |
| Enlist Duo + Example 3 | 11.31 | 28.44 | 100 |
| Enlist Duo + Example 4 | 11.22 | 28.39 | 100 |
| Enlist Duo + Example 5* | 11.83 | 29.22 | 100 |
| Enlist Duo + Example 6* | 13.21 | 31.08 | 100 |

*comparative

The addition of the drift control formulations of the invention results in limited coarser spray with a reduced percentage of small droplets having a diameter below 150 microns. Examples 3 and 4 show comparable results using both the nozzles. The drift control premix containing a maltodextrin and a C₁₂-C₂₂ monocarboxylic acid of Examples 3 and 4 show lower Pct below 150 and 210 μm than those show by either the only C₁₂-C₂₂ monocarboxylic acid (Example 5) or the only maltodextrin (Example 6). This test demonstrates the optimal spray drift properties of the drift control formulations of the invention.

1. A method for reducing spray drift during spray applications of a solution comprising mixing the solution with a drift control formulation comprising a maltodextrin and a member selected from the group consisting of a C₁₂-C₂₂ carboxylic acid, a C₁₂-C₂₂ di-carboxylic acid, a salt of a C₁₂-C₂₂ carboxylic acid, a salt of a C₁₂-C₂₂ di-carboxylic acid and combinations thereof.

2. (canceled)

3. The method of claim 2 wherein the solution is mixed with from 0.05 to 2 percent vol/vol of the drift control formulation that contains from 20 to 75% by weight of a maltodextrin and from 1 to 5% by weight of a member selected from the group consisting of a C₁₂-C₂₂ carboxylic acid, a C₁₂-C₂₂ di-carboxylic acid, a salt of a C₁₂-C₂₂ carboxylic acid, a salt of a C₁₂-C₂₂ di-carboxylic acid and combinations thereof.

4. The method of claim 3 wherein the drift control formulation comprises from 20 to 79% by weight of water.

5. The method of claim 1 wherein the C₁₂-C₂₂ mono- or di-carboxylic acid is a C₁₂-C₂₂ fatty acid.

6. The method of claim 5 wherein the C₁₂-C₂₂ fatty acid is olein.

7. The method of claim 1 wherein the C₁₂-C₂₂ mono- or di-carboxylic acid is a C₈-C₁₈ alkyl or alkenyl succinic acid.

8. The method of of claim 1 wherein the pesticidal or crop protection spray tank solution is a herbicidal solution.

9. The method of claim 8 wherein the herbicidal solution contains a member selected from the group consisting of glyphosate, 2,4-D, glufosinate, dicamba, atrazine, paraquat, triclopyr, aminopyralid and mixtures thereof.

10. The method of claim 9 wherein the herbicidal solution contains glyphosate and 2,4-D.

11. The method of claim 1 wherein the maltodextrin is underivatized.

12. The method of of claim 11 wherein the C₁₂-C₂₂ mono- or di-carboxylic acid is a C₁₂-C₂₂ fatty acid.

13. The method of claim 12 wherein the C₁₂-C₂₂ fatty acid or salt thereof is olein.

14. The method of claim 1 wherein the maltodextrin is underivatized and the C₁₂-C₂₂ mono- or di-carboxylic acid is a C₈-C₁₈ alkyl or alkenyl succinic acid.

15. The method of claim 1 wherein the maltodextrin is hydrophobically modified.

16. The method of of claim 15 wherein the hydrophobically modified maltodextrin is a maltodextrin fatty ester of a C₁₂-C₂₂ fatty acid having hydrophobic degree of substitution from 10⁻⁴ to 0.1 and the C₁₂-C₂₂ mono- or di-carboxylic acid is a C₁₂-C₂₂ fatty acid.

17. The method of claim 16 wherein the maltodextrin fatty ester is maltodextrin oleate and the C₁₂-C₂₂ fatty acid is olein.

18. The method of of claim 15 wherein the hydrophobically modified maltodextrin is a maltodextrin monoester of a C₈-C₁₈ alkyl or alkenyl succinic acid having hydrophobic degree of substitution from 10⁻⁴ to 0.1 and the C₁₂-C₂₂ mono- or di-carboxylic acid is a C₈-C₁₈ alkyl or alkenyl succinic acid.

19. A drift control formulation containing from 20 to 75% by weight of a maltodextrin, from 1 to 5% by weight of a member selected from the group consisting of a C₁₂-C₂₂ carboxylic acid, a C₁₂-C₂₂ di-carboxylic acid, a salt of a C₁₂-C₂₂ carboxylic acid, a salt of a C₁₂-C₂₂ di-carboxylic acid and combinations thereof, and from 20 to 79% by weight of water.

20. The drift control formulation of claim 19 wherein the maltodextrin is underivatized.

21. The drift control formulation of claim 20 wherein the C₁₂-C₂₂ mono- or di-carboxylic acid is a C₁₂-C₂₂ fatty acid.

22. The drift control formulation of claim 21 wherein the C₁₂-C₂₂ fatty acid is olein.

23. The drift control formulation of claim 20 wherein the C₁₂-C₂₂ mono- or di-carboxylic acid is a C₈-C₁₈ alkyl or alkenyl succinic acid.

24. The drift control formulation of claim 19 wherein the maltodextrin is hydrophobically modified.

25. The drift control formulation of claim 24 wherein the hydrophobically modified maltodextrin is a maltodextrin fatty ester of a C₁₂-C₂₂ fatty acid having hydrophobic degree of substitution from 10-4 to 0.1 and the C₁₂-C₂₂ mono- or di-carboxylic acid is a C₁₂-C₂₂ fatty acid.

26. The drift control formulation of claim 25 wherein the maltodextrin fatty ester is maltodextrin oleate and the C₁₂-C₂₂ fatty acid is olein.

27. The drift control formulation of claim 26 wherein the hydrophobically modified maltodextrin is a maltodextrin monoester of a C₈-C₁₈ alkyl or alkenyl succinic acid having hydrophobic degree of substitution from 10⁻⁴ to 0.1 and the C₁₂-C₂₂ mono- or di-carboxylic acid is a C₈-C₁₈ alkyl or alkenyl succinic acid.
